(19) United States
(12) Patent Application Publication
(10) Pub. No.: US 2002/0040381 A1
(43) Pub. Date: Apr. 4, 2002

(54) Automatic load distribution for multiple digital signal processing system

(76) Inventors: Dianne L. Steiger, Irvine, CA (US); Saurin Shah, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/967,420

(22) Filed: Sep. 28, 2001

Related U.S. Application Data
(60) Provisional application No. 60/237,664, filed on Oct. 3, 2000.

(51) Int. Cl. G06F 9/00

(52) U.S. Cl. 709/102

(57) ABSTRACT

One aspect of the invention provides a novel scheme to perform automatic load distribution in a multi-channel processing system. A scheduler periodically creates job handles for received data and stores the handles in a queue. As each processor finishes processing a task, it automatically checks the queue to obtain a new processing task. The processor indicates that a task has been completed when the corresponding data has been processed.

### CROSS REFERENCE TO RELATED APPLICATIONS

This non-provisional United States (U.S.) Patent Application claims the benefit of U.S. Provisional Application No. 60/237,664 filed on Oct. 3, 2000 by inventors Saurin Shah et al. and titled “AUTOMATIC LOAD DISTRIBUTION FOR MULTIPLE DSP CORES”.

### FIELD

The invention pertains generally to digital signal processors. More particularly, the invention relates to a method, apparatus, and system for performing automatic load balancing and distribution on multiple digital signal processor cores.

### BACKGROUND

Digital signal processors (DSP) are employed in many applications to process data over one or more communication channels. In a multi-channel data processing application, maximum utilization of the processing resources increases the speed with which data can be processed, and, as result, increases number of channels that can be supported.

A DSP core is a group of one or more processors configured to perform specific processing tasks in support of the overall system operation. Efficient use of the DSP cores and other available processing resources permits a DSP to process an increased amount of data.

Various methods and schemes have been employed to increase the efficiency of DSPs. One such scheme involves the use of scheduling algorithms.

Scheduling algorithms typically manage the distribution of processing tasks across the available resources. For example, a scheduling algorithm may assign a particular DSP or DSP core the processing of a particular data packet.

Generally, it is inefficient for schedulers to run continuously since this consumes system resources thereby slowing processor operations. Rather, schedulers periodically awaken to assign tasks, such as processing received data packets, to the DSP resources. However, because data packets are often of different lengths, it may be that some processors remain idle between the time the processor finishes a processing task and the next time the scheduler awakens to assign it a new task. This is particularly true in a system in which the time required to process frames from different channels, or even to process different frames for the same channel varies widely. This is a common condition in many multi-channel packet processing systems. This processor idle time is wasteful and an inefficient use of DSP resources.

### BRIEF DESCRIPTION OF THE DRAWINGS

FIG. 1 is a diagram illustrating a first configuration in which devices embodying the invention may be employed.

FIG. 2 is another diagram illustrating a second configuration in which devices embodying the invention may be employed.

FIG. 3 is a block diagram illustrating one embodiment of a device embodying the invention.

FIG. 4 is a block diagram illustrating one embodiment of a multi-channel packet processing system in which the invention may be embodied.

FIG. 5 is a diagram illustrating multiple packet data channels on which the invention may operate.

FIG. 6 is an illustration of one embodiment of an Execution Queue as it is accessed by a scheduler according to one aspect of the invention.

FIG. 7 is an illustration of one embodiment of an Execution Queue as it is accessed by processing resources according to one aspect of the invention.

FIG. 8 is a diagram illustrating how processing resources perform automatic load distribution according to one embodiment of the invention.

FIG. 9 is a diagram illustrating one implementation of a method for performing automatic load distribution according to the scheduling aspect of the invention.

FIG. 10 is a diagram illustrating one implementation of a method for performing automatic load distribution according to one embodiment of the processing resources of the invention.

FIG. 11 is a block diagram illustrating one implementation of a processing resource which may be employed in one embodiment of the invention.

### DETAILED DESCRIPTION

In the following detailed description of the invention, numerous specific details are set forth in order to provide a thorough understanding of the invention. However, one of ordinary skill in the art would recognize that the invention may be practiced without these specific details. In other instances well known methods, procedures, and/or components have not been described in detail so as not to unnecessarily obscure aspects of the invention.

While the term digital signal processor (DSP) is employed in various examples of this description, it must be clearly understood that a processor, in the broadest sense of the term, may be employed in this invention.

One aspect of the invention provides a scheduling algorithm which automatically distributes the processing load across the available processing resources. Rather than relying on the scheduler to assign tasks, the processing resources seek available work or tasks when they become free. This aspect of the invention minimizes the processor idle time, thereby increasing the number of tasks or jobs which can be processed.

FIGS. 1 and 2 illustrate various configurations in which Devices A, B, C, D, E, F, G, and H embodying the invention may be employed in a packet network. Note that these are exemplary configurations and many other configurations exist where devices embodying one or more aspects of the invention may be employed.

FIG. 3 is a block diagram of one embodiment of a device 302 illustrating the invention. The device 302 may include an input/output (I/O) interface 304 to support one or more data channels, a bus 306 coupled to the I/O interface 304, a processing component 308, and a memory device 310. The processing component 308 may include one or more processors and other processing resources (i.e., controllers, etc.) to process data from the bus and/or memory device 310. The memory device 310 may be configured as one or more data queues. In various embodiments, the device 302 may be part of a computer, a communication system, one or more circuit cards, one or more integrated devices, and/or part of other electronic devices.

According to one implementation, the processing component 308 may include a control processor and one or more application specific signal processors (ASSP). The control processor may be configured to manage the scheduling of data received over the I/O interface 304. Each ASSP may comprise one or more processor cores (groups of processors). Each core may include one or more processing units (processors) to perform processing tasks.

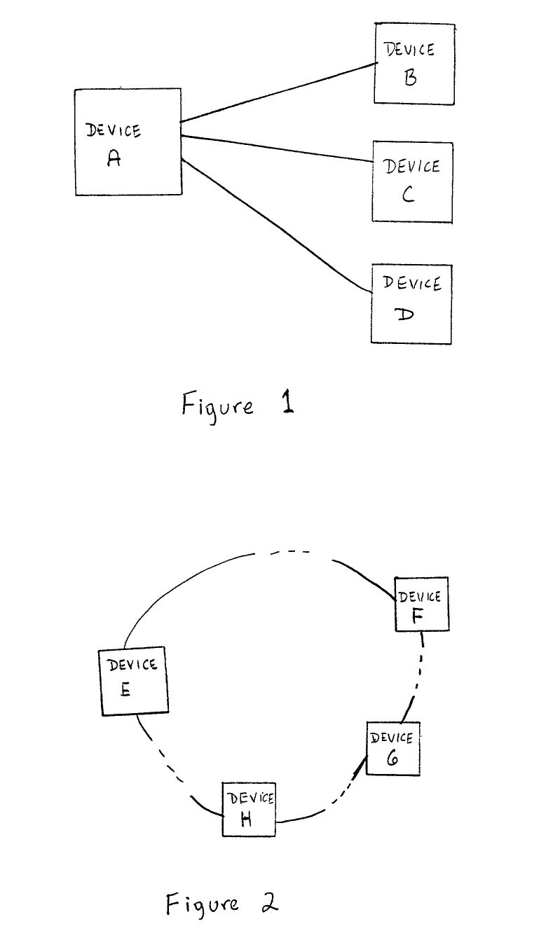

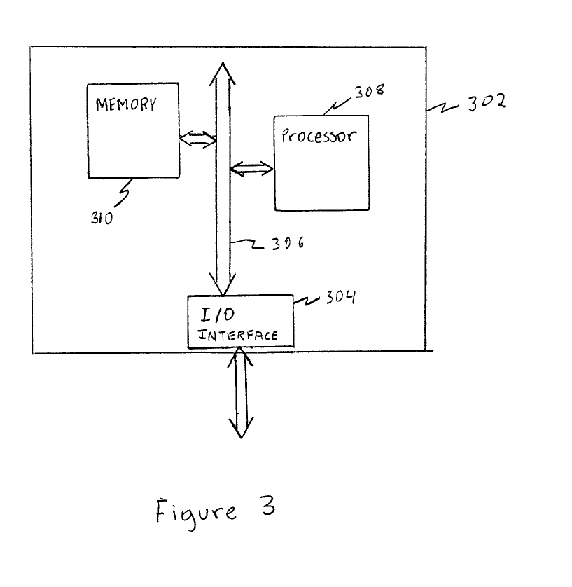

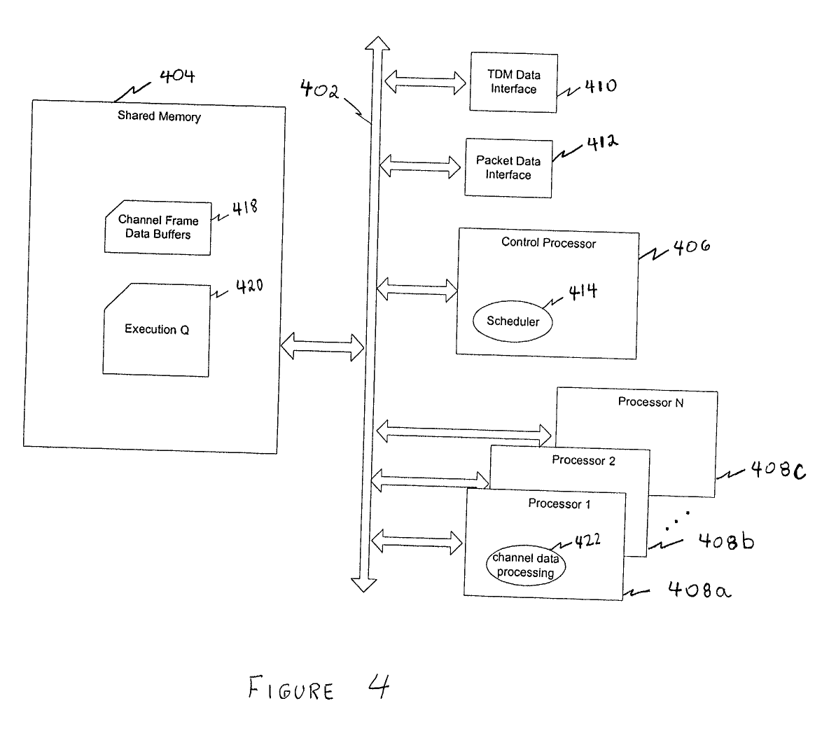

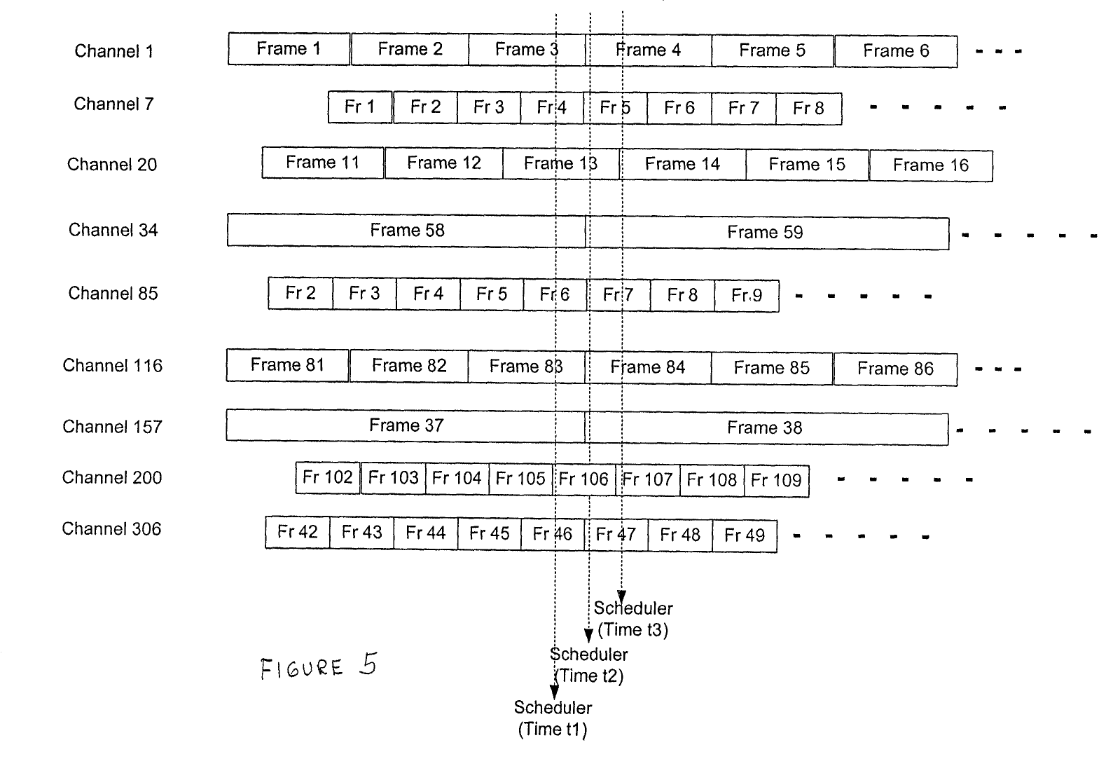

FIG. 4 is a block diagram illustrating one embodiment of a multi-channel packet processing system in which the invention may be embodied. One system in which the automatic load distribution scheduler may be implemented is a multi-channel packet data processor (shown in FIG. 4). The system includes a bus 402 communicatively coupling a memory component 404, a control processor 406, a plurality of digital signal processors 408, and data input/output (I/O) interface devices 410 and 412. The I/O interface devices may include a time-division multiplexing (TDM) data interface 410 and a packet data interface 412. The control processor 406 may include a direct memory access (DMA) controller.

The multi-processor system illustrated in FIG. 4 may be configured to process one or more data channels. This system may include software and/or firmware to support the system in processing and/or scheduling the processing of the data channel(s).

The memory component 404 may be configured as multiple buffers and/or queues to store data and processing information. In one implementation, the memory component 404 is a shared memory component with one or more data buffers 418 to hold channel data or frames, and an Execution Queue 420 to hold data/frame processing information for the scheduler 414.

The multi-channel packet processing system (FIG. 4) may be configured so that the automatic load distribution aspect of the invention distributes channel data processing tasks across the multiple processors 408 in the system. This aspect of the invention is scalable to a system with any number of processing resources. Moreover, the automatic load distribution aspect of the invention is not limited to multi-channel systems and may also be practiced with single channel and/or single processor systems.

In one embodiment, the system controller 406 may perform all I/O and control related tasks including scheduling processing of the data channels or data received over the data channels. The scheduling algorithm or component is known as the scheduler 414. The processors 408 perform all data processing tasks and may include a channel data processing algorithm or component 422. Examples of the data processing tasks performed by the processors 408 include voice compression and decompression, echo cancellation, dual-tone/multi-frequency (DTMF) and tone generation and detection, comfort noise generation, and packetization.

According to one implementation, data processing for a particular channel is performed on a frame-by-frame basis. For example, the Packet Data Interface 412 or TDM Data Interface 410 receive a frame over a channel and store it in the memory component 404 (i.e., in the channel data buffers 418). Likewise, scheduling algorithm 414 schedules the task of processing each frame on a frame-by-frame basis. Since channels are generally asynchronous to each other, if multiple channels are active, frames are typically available to be processed continuously. Another implementation may perform processing on groups of frames or multiple frames at one time. For example, two frames of data may be accumulated before scheduling them for processing. Similarly, multiple frames may be accumulated before scheduling them for processing as a single task.

Because it is generally inefficient to design a system in which the scheduler runs continuously, tasks such as scheduling are done on a periodic basis, and all frames which are ready to be processed during a particular period are scheduled at the same time.

As discussed above, processing resources may be idle even though packets are available to be processed. That is, after a processor finishes a processing task it stays idle until the next time the scheduler runs and assigns it another task. This is particularly true in a system in which the time required to process frames from different channels, or even to process different frames for the same channel varies widely. This is a common condition in many multi-channel packet processing systems. For example, where the packets processed by a system vary in size or length, some processing resources will finish a processing task before others.

According to the automatic load distribution scheduling algorithm aspect of the invention, all frames which are ready to be processed at a current scheduling period are scheduled on that period. The processing resources (i.e. processors 408) of the invention are continuously either processing a frame, or looking for a new frame to process. Thus, the processors are only idle if there is no data to process.

In conventional scheduling algorithms where the scheduler assigns processing tasks to a particular resource, minimizing the idle time of the processing resources typically requires a more complicated scheduler. For example, the scheduler may have to keep track of how long a resource will take to process a frame so that it knows when that resource will be available again. This requires that the scheduler have some knowledge of the type of processing required by the frame. For some tasks or frames, the amount of processing required for the task or frame may not be determinable at the time the task or frame is scheduled.

With the automatic load distribution algorithm of the invention, the scheduler 414 does not require any information about the processing required for a task or frame. In one implementation, frames of data to be processed arrive asynchronously for a variable number of active channels.

FIG. 5 is an example of the arrival of frames of data for a number of active channels in the system. The frame sizes illustrated vary depending on the channel. FIG. 5 also shows three consecutive times for which the scheduler 414 runs (t1, t2, t3), and which channels have frames ready to be processed.

At time t1 for example, only frame 105 for channel 200 is ready. At time t2, seven channels have frames ready for processing—channel 1 frame 3, channel 7 frame 4, channel 34 frame 58, channel 85 frame 6, channel 116 frame 83, channel 157 frame 37, and channel 306 frame 46. At time t3, channel 20 frame 13 and channel 200 frame 106 are ready to be processed.

The system described herein is scalable and can support from one channel to hundreds of channels. The types of channels supported by this system may include T1 or E1 compliant TDM channels (compliant with American National Standards Institute (ANSI) Standard T1 and E1 and as established by various T1 and E1 standards since 1984, International Telecommunication Union (ITU)-T Standard G.703 rev.1, and International Telegraph and Telephone Consultative Committee (CCITT) Standard G.703 rev.1) as well as packetized data channels. A frame of data is a group of samples associated with a particular channel which are processed together. Frame sizes may vary depending on the processing which must be performed. For example, a G.711 frame (International Telecommunication Union (ITU) Recommendation G.711) may include 40, 80, 160, or 240 voice samples.

When a frame or frames of data associated with a channel are ready to be processed, a “job handle” is entered into an Execution Queue. In this context, the job handle is a pointer to a structure which contains any information which the processing resource may need in order to process the frame. For instance, the pointer may point to a buffer and offset containing the data frame to be processed. Each processing resource then obtains the next available job handle as the processing resource becomes idle.

According to one implementation, the Execution Queue 420 is a circular queue of fixed length. In another implementation, the Execution Queue 420 is a variable length queue.

FIG. 6 illustrates how in one implementation of the invention the scheduler may schedule the processing jobs (i.e., frames) shown in FIG. 5 for processing. At time t1, the scheduler places a job handle for channel 200 frame 105 in the Execution Queue at location one (1), and changes the Scheduler Tail Pointer to point to this location. At time t2, the scheduler places the job handles for the seven channels (channels 1, 7, 34, 85, 116, 157, and 306) with frames ready to be processed at the next seven consecutive locations (locations two (2) through eight (8)) in the Execution Queue, and then changes the Scheduler Tail Pointer to point to the last job entered (at location eight (8)).

Similarly, at time t3, the scheduler enters the job handle for channel 20 frame 13 and channel 200 frame 106, and modifies the Scheduler Tail Pointer to point to location ten (10).

In this manner, the scheduler fills the Execution Queue with jobs to process.

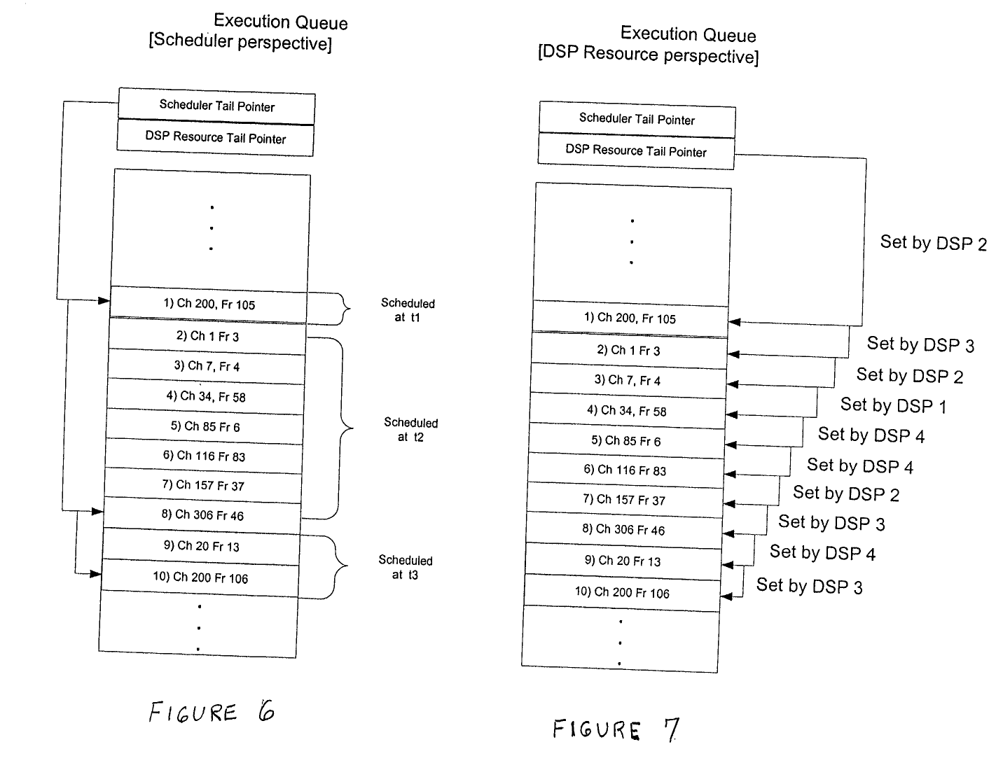

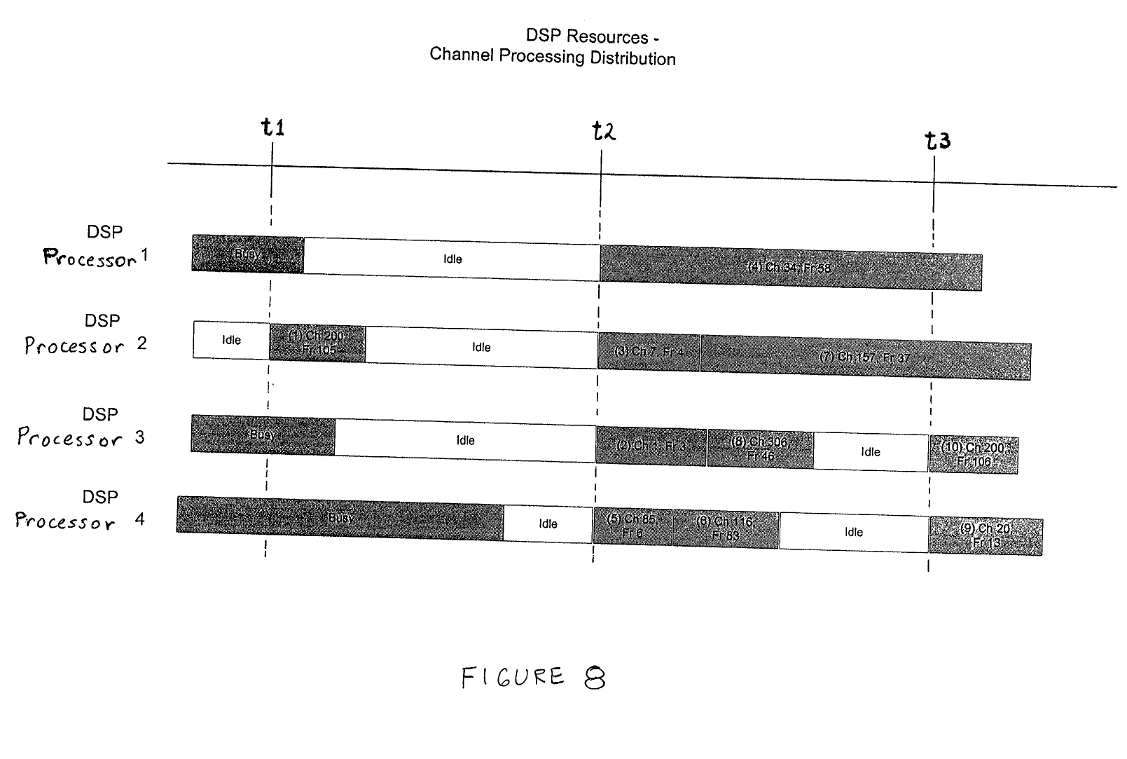

FIG. 7 illustrates how in one implementation of the invention the processing resources (i.e., four DSPs in this example) would obtain the processing jobs shown in FIG. 6 for processing. As each DSP finishes processing a frame, it checks the Execution Queue for the next available frame. If a frame is available to be processed, the processor obtains the next available job handle and processes the corresponding frame. In this manner, the DSPs empty the Execution Queue by processing the jobs. When no job handles are available for processing, the DSPs remain idle until additional frames are received.

In one implementation, the job handle may also be used to indicate the status of the job (e.g. scheduled, being processed, processing done).

According to one implementation, a semaphore is used by the scheduler and DSP processors when necessary to “lock” the Execution Queue when the information is being updated. This mechanism ensures that a particular job on the Execution Queue will be processed by only one of the DSP processors.

In one implementation, the Execution Queue comprises a number of locations in which to store the job handles, a Scheduler Tail Pointer, and a DSP Resource Tail Pointer. The Scheduler Tail Pointer points to the last location on the Execution Queue where the scheduler entered a job handle. The scheduler uses a semaphore to lock the queue when it is updating the Scheduler Tail Pointer.

Each processing resource searches the Execution Queue when it is ready to process a new job. It uses a semaphore to lock the queue while it is searching to prevent multiple resources from acquiring the same job. When a processing resource (i.e. a DSP processor) finds a job to process, it updates the job status in the job handle to indicate that it is processing the job, and also updates the Resource Tail Pointer to point to the location of the job in the queue.

In one implementation, the use of the Execution Queue Tail Pointers as described above ensures that the jobs will be processed in the order in which they were entered in the Execution Queue (e.g. the oldest job in the queue will be the next one to be processed).

The scheduler searches the Execution Queue for the jobs which the processing resources have finished processing to perform additional tasks required by the system, and to clear the job handle from the Execution Queue.

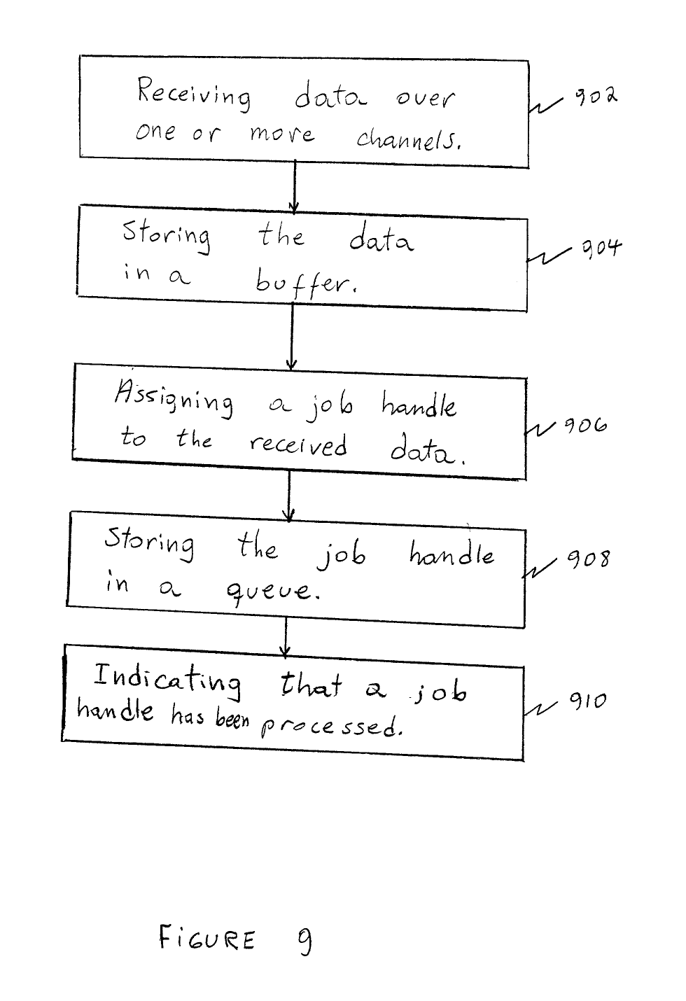

FIGS. 8 is another illustration of how the DSP processors might take the jobs from the Execution Queue for processing. FIG. 8 is another representation of the DSP processing example shown in FIG. 7. As shown in FIG. 8, at time t1, DSP processors 1, 3, and 4 are already busy processing previously scheduled jobs. DSP processor 2 is idle at time t1, so it will be searching the Execution Queue for a job. The DSP processors only need to search the Execution Queue in the queue locations between the DSP Resource Tail Pointer and the Scheduler Tail Pointer. In this example, DSP processor 2 finds the job handle at location one (1), moves the Resource Tail Pointer to this location (see FIG. 7) and begins processing this job.

In this example, as shown in FIG. 8, all four DSP processors 1, 2, 3, and 4 become idle prior to scheduler time t2 since there are no more jobs in the Execution Queue to process.

At scheduler time t2, all four DSP processors are idle (as shown in FIG. 8), so all four processors are searching the Execution Queue for new processing jobs. The processor which gets the next job depends on which processor acquires the semaphore for the Execution Queue first. In this example, DSP processor 3 acquires the Execution Queue semaphore first, so it takes the next job in the Execution Queue which is at location two (2), channel 1 frame 3, moves the DSP Resource Tail Pointer to location two (2), and releases the Execution Queue semaphore.

Since seven jobs were scheduled at scheduler time t2, each of the idle DSP processors will find a job to process. As shown in FIG. 4, DSP processor 2 takes the job in location three (3), DSP processor 4 takes the job at location five (5).

DSP processors 2,3, and 4 finish the first jobs which they took from the Execution Queue prior to scheduler time t3. These processors then immediately search the Execution Queue for another job to process. There are still three jobs to process at this point—at Execution Queue locations six (6), seven (7), and eight (8). Since DSP processor 4 is the first to finish, it takes the next job which is channel 116 frame 83, at Queue location (6). DSP processor 2 is the next to finish, and takes the job at location seven (7). When DSP processor 3 finishes, it takes the job at location eight (8). FIG. 7 shows the sequence in which the Execution Queue DSP Resource Tail Pointer is updated by the DSP processors during this time.

When DSP processor 4 finishes the job at location six (6), all of the jobs currently on the Execution Queue have been processed, or are already being processed, so DSP processor 4 becomes idle. Similarly, when DSP processor 3 finishes the job at location eight (8), it too becomes idle.

At scheduler time t3, two of the DSP processors are still busy (DSP processors 1 and 2). DSP processors 3 and 4 are idle, and will take the jobs at location nine (9) and ten (10).

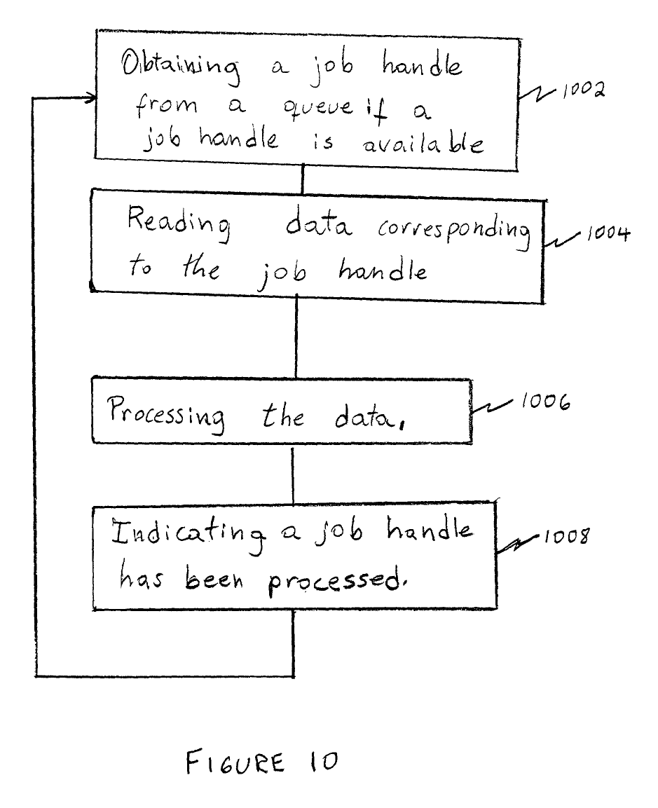

FIG. 9 illustrates an exemplary method by which one implementation of a task scheduler may perform the scheduling aspect of the invention. Data is first received over one or more channels 902. The data is stored in a buffer 904 pending processing. A job handle is assigned to a unit of data received 906. For example, each packet or frame may be assigned a unique job handle. The job handle is stored in a queue 908. According to one implementation, the queue is configured as a first in, first out queue. The scheduler may use a pointer to keep track of the last entry into the queue. In one implementation, the scheduler removes a job handle when the corresponding data has been processed 910.

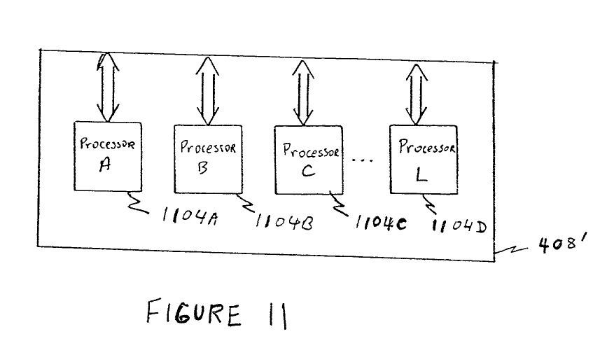

FIG. 10 illustrates an exemplary method by which one implementation of the processing resources may perform automatic load distribution according to one aspect of the invention. When a processing resource has finished a job, it attempts to obtain a new job handle from a list of job handles 1002. If an unprocessed job handle is available, the processing resource then reads the corresponding data to be processed 1004. The data is then processed 1006 and the processing resource indicates that the job has been processed 1008.

A person of ordinary skill in the art would recognize that various aspects of the invention may be implemented in different ways without deviating from the invention.

The implementation described above uses one Execution Queue for all jobs which require processing. According to one implementation, the status of the jobs is contained within the job handles themselves. That is, the status of the job may be stored as part of the job handle.

In another embodiment, the system includes both an Execution Queue and a Job Done Queue. The scheduler enters jobs which require processing on the Execution Queue. The processing resources (DSPs) search the Execution Queue for jobs to process. However, when the processing resource finishes processing the job, it enters the job handle for the job which it processed on the Job Done Queue. The scheduler searches the Job Done Queue to determine which jobs have been completed.

There are several advantages to the dual queue approach. One is that the Execution Queue is not “locked” as often, so both the processing resources (DSPs) and the scheduler are not locked out from accesses as frequently. The second advantage is that the scheduler does not have to keep track of Execution Queue wrap-around conditions. This condition occurs when jobs taken by the processing resources are not completed in the order in which they were taken. That is, the Scheduler Tail Pointer wraps past the Processing Resource Tail Pointer causing a wraparound condition.

Another embodiment of the scheduling algorithm implements multiple Execution Queues with different priorities. Multiple Execution Queues are useful in systems which must support data processing with varying priorities. This allows higher priority frames and/or channels to be processed prior to lower priority jobs regardless of the order in which they were received.

In one implementation of multiple Execution Queues, the processing resources may be set-up so that at least some of the processors always search the higher priority queue(s), and then the lower priority queue(s).

The invention may be practiced in hardware, firmware, software, or a combination thereof. According to one embodiment, shown in FIG. 11, each processor or processing resource 408′, a variation of processors 408 in FIG. 4, may comprise a plurality of parallel processors to process a given task. Each processing resource 408′ may be configured to process one or more tasks or frames concurrently.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Additionally, it is possible to implement the invention or some of its features in hardware, programmable devices, firmware, software or a combination thereof. The invention or parts of the invention may also be embodied in a processor readable storage medium or machine-readable medium such as a magnetic, optical, or semiconductor storage medium.

What is claimed is:

1. A method comprising:
placing one or more job handles, corresponding to new processing jobs, in a queue as new jobs are periodically detected by a load distribution scheduler; and
obtaining a job handle from the queue as processing resources become idle so that the processing resources do not remain idle while there are jobs to be processed.

2. The method of claim 1 further comprising:
receiving data over one or more data channels; and
storing the data in a memory buffer.

3. The method of claim 1 wherein the data channels are asynchronous data channels.

4. The method of claim 1 further comprising:
updating a first pointer to point to the location in the queue of the last job handle placed in the queue.

5. The method of claim 1 further comprising:
updating a second pointer to point to the location in the queue of the last job handle obtained.

6. The method of claim 1 further comprising:
marking a job handle as done when the corresponding job has been completed.

7. The method of claim 1 further comprising:
removing a job handle from the queue when the corresponding job has been processed.

8. The method of claim 1 wherein the jobs include data frames.

9. The method of claim 8 wherein the data frames are of varying lengths.

10. The method of claim 1 wherein the method operates as an automatic load distribution method for a multi-channel system.

11. The method of claim 1 wherein the queue is partitioned into multiple queues, each queue to store job handles of varying priority levels.

12. The method of claim 1 further comprising:
processing higher priority jobs before lower priority jobs.

13. An apparatus comprising:
an input port;
a storage device communicatively coupled to the input port;
a controller device communicatively coupled to the storage device and configured to periodically take received data from the input port and store it in the storage device; and
one or more processors communicatively coupled to the storage device, the processors configured to automatically read data from the storage device and process the data while unprocessed data remains in the storage device.

14. The apparatus of claim 13 wherein the storage device is configured to include a queue for holding job handles corresponding to the unprocessed data in the storage device.

15. The apparatus of claim 14 wherein a first pointer points to the location in the queue of the last job handle placed in the queue.

16. The apparatus of claim 14 wherein a second pointer points to the location in the queue of the last job handle obtained by one of the one or more processors.

17. The apparatus of claim 14 wherein the one or more processors obtain a job handle from the queue in order to process the next unprocessed data.

18. The apparatus of claim 14 wherein the job handles are obtained by the one or more processors in the order in which the corresponding data was received.

19. The apparatus of claim 14 wherein job handles are removed from the queue once the corresponding data has been processed.

20. The apparatus of claim 13 wherein the storage device is configured to include a plurality of queues for holding job handles according to the priority levels of the data received.

21. The apparatus of claim 13 wherein the one or more processors process higher priority data before lower priority data.

22. The apparatus of claim 13 wherein the input port provides multiple data channels, one or more data channels asynchronous to one or more of the other data channels.

23. The apparatus of claim 13 wherein the data is received in the form of frames.

24. A machine-readable medium having one or more instructions to automatically perform load distribution in a multi-channel processing system, which when executed by a processor, causes the processor to perform operations comprising:
periodically detecting new frames to be processed;
storing new frames in a buffer; and
placing job handles, corresponding to the new frames, in a queue.

25. The machine-readable medium of claim 24 further comprising:
removing a job handle from the queue when its corresponding frame has been processed.

26. The machine-readable medium of claim 24 further comprising:
updating a pointer to point to the last job handle in the queue.

27. A machine-readable medium having one or more instructions to automatically perform load distribution in a multi-channel processing system, which when executed by a processor, causes the processor to perform operations comprising:
automatically attempting to obtain a job handle from a queue whenever a processing task has been completed;
reading the data corresponding to the job handle from a memory buffer; and
processing the data corresponding to the job handle.

28. The machine-readable medium of claim 27 further comprising:
indicating that data corresponding to a job handle has been processed.

29. The machine-readable medium of claim 27 further comprising:
updating a pointer to point to the next job handle in the queue corresponding to unprocessed data.

30. The machine-readable medium of claim 27 further comprising:
obtaining higher priority job handles before lower priority job handles.
